(19) United States
(12) Patent Application Publication
(10) Pub. No.: US 2006/0271345 A1
(43) Pub. Date: Nov. 30, 2006

(54) Debugging a circuit using a circuit simulation verifier

(76) Inventor: Atsushi Kasuya, Sunnyvale, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/132,742

(22) Filed: May 18, 2005

(51) Int. Cl. G06F 17/50

(52) U.S. Cl. 703/14

(57) ABSTRACT

A circuit is tested using a device under test, a circuit simulator, and a circuit simulation verifier. Executing the verifier drives the simulator and collects trace information. This trace information enables the verifier to be executed backwards to a past execution point or clock cycle. The internal state of the verifier's execution is reconstructed at the past point. A state of verifier execution includes values of variables (including any ports or clocks) and an execution point (e.g., which code statement was last executed). A past state of execution can be determined by using trace information to modify the current state of execution. After a line of trace information has been processed, the “current” state of verifier execution becomes the previous state as modified based on the trace information.

### CROSS-REFERENCE TO RELATED PATENTS

The following U.S. patents are hereby incorporated by reference:

U.S. Pat. No. 5,905,883, entitled “Verification System for Circuit Simulator,” issued May 18, 1999; and

U.S. Pat. No. 6,077,304, entitled “Verification System for Simulator,” issued Jun. 20, 2000.

### BACKGROUND OF THE INVENTION

1. Field of the Invention

The present invention is related to circuit design verification and, more particularly, to debugging a program that is used to control a circuit simulator.

2. Description of the Background Art

Software has long been used to verify the correctness of integrated circuit designs. First, a computer-based model of a circuit, generally known as a device under test (DUT), is created. A DUT is a set of statements written in a Hardware Description Language (HDL), such as Verilog or VHDL, which describes a circuit's design. Specifically, HDL describes the structural state of the circuit's hardware, including connectivity information (e.g., wires) and elements (e.g., modules).

Then, the DUT is tested by applying test patterns to its input ports and observing signals at its output ports. For each test, a particular input test pattern should result in a particular output signal, if the circuit is designed correctly. Signals at the circuit's output ports are observed over time to determine whether the inputs were transformed into the correct outputs.

A circuit simulation software application, such as Verilog-XL, simulates operation of the circuit based on the DUT code. Since the structure of a circuit's hardware is generally static, the simulator can statically declare a variable that represents a node in the circuit. As a result, it is relatively easy for a simulator to trace variable values while the simulation is being performed and display these values in a waveform format.

The most common way to test a circuit model is by writing a program that applies input test patterns and analyzes output signals. This program, often called a test bench, can be very simple or very complex. Because of the inherently parallel nature of complex electronic circuits, parallel programming techniques must often be used in order to test a circuit effectively. In addition, sometimes the correct behavior of a circuit involves several events that are not expected to occur at specific times but are expected to occur in a specific order. It is very difficult to write a test bench that takes into account these types of time and ordering ambiguities or uncertainties.

The concept of a Hardware Verification Language (HVL), also known as a Design Verification Language (DVL), was developed in order to meet this need. A program written using an HVL is used to control a circuit simulator and verify the correctness of the circuit's behavior as predicted by the simulator. An HVL, such as Vera or Jeda, enables a user to create a program that manipulates data using variables and operations. However, an HVL also has additional features that are useful for controlling a simulator and verifying the correctness of a circuit's behavior. A description of these features can be found in Appendix A.

A program written using an HVL (known as a “circuit simulation verifier”) enables circuit simulation based on dynamic threads rather than on static structure of concurrent elements (as in HDL) and enables a circuit to be tested from a procedural point of view. As a result, a circuit simulation verifier can define and verify the operational correctness and performance characteristics of a complex circuit without having to precisely define exactly when associated signal combinations must occur. A verifier also makes it possible to accommodate signal-ordering ambiguities.

Circuit simulation verifiers have been used to control the operation of circuit simulators. However, due to HVL's dynamic nature, a simulator controlled by a circuit simulation verifier must dynamically allocate and deallocate variables and execution threads. In addition, the circuit simulation verifier must monitor the circuit simulator's simulation time (e.g., clock cycle). As a result, it is impossible for such a simulator to provide waveform-based debugging similar to that used with standard HDL simulators.

What is needed is a way to debug a circuit that has been tested using an HVL-driven simulator. In particular, a user should be able to “rewind” a simulation to a past execution point or simulation time.

### SUMMARY OF THE INVENTION

A circuit is tested using a device under test (DUT), which is a description of the circuit's static structure (including gates, wires, and a behavioral model) written in a Hardware Description Language (HDL); a circuit simulator, which is a program that simulates the circuit's operation based the DUT; and a circuit simulation verifier, which is a program written in a Hardware Verification Language (HVL), such as Vera or Jeda, that controls the circuit simulator and verifies the simulator's behavior.

Executing the verifier drives the simulator and collects trace information, which can be used to debug the circuit. This trace information can include, for example, values and value changes of elements (in the circuit), values and value changes of variables (in the verifier program), and clock cycles or timestamps. In one embodiment, the verifier drives the simulator within a debugging environment, which can be passive and/or interactive. For example, information can be saved to a file and/or a user can control the execution of the verifier and/or simulator. In one embodiment, execution control includes stopping and starting execution, skipping execution of statements, and changing values in memory.

In one embodiment, a debugger enables a user to execute the verifier backwards to a past execution point or clock cycle. Recorded sequence information is traced back, and the internal state of the verifier's execution (e.g., the value of each variable) is reconstructed at the past point. The verifier can be executed backwards to any past execution point, such as: one line of code back from the current point, a point where the value of a particular variable was modified, or a particular line of code.

This functionality is enabled by using trace information that was collected during verifier and/or simulator execution. For example, verifier source code (HVL) is written and then compiled, which results in assembly code. In one embodiment, the assembly code that is created includes additional information that is useful debugging, such as line and file information. When the assembly code is executed, trace information is collected. This trace information enables the internal state of the verifier's execution (e.g., the value of each variable) to be reconstructed at a later point.

A state of verifier execution includes values of variables (including any ports or clocks) and an execution point (e.g., which assembly code statement was last executed). A past state of execution can be determined by using trace information to modify the current state of execution. In one embodiment, the last (most recent) line of trace information is read. If that line includes a value change of a variable, then the value of that variable (in the “current” state) is set. to the “old” value. If that line includes debugging information (such as line number and file name), then the execution point within the verifier (in the “current” state) is set to the “old” value (e.g., the number of the previous line). This procedure can be repeated multiple times, depending on how far backward the user wants to execute the verifier. After a line of trace information 335 has been processed, the “current” state of verifier execution becomes the previous state as modified based on the trace information.

### BRIEF DESCRIPTION OF THE DRAWINGS

FIG. 1A illustrates a clock-based timeline for simulator execution and verifier execution.

FIG. 1B illustrates a flowchart of a method for using a circuit simulation verifier to debug a circuit.

FIG. 2 illustrates a graphical user interface to the verifier.

FIG. 3 illustrates a flowchart of a method for producing source code, assembly code, and trace information.

FIG. 4A illustrates a flowchart of a method for collecting trace information and executing assembly code.

FIG. 4B illustrates a table of assembly code and trace information.

FIG. 5A illustrates source code for a single-threaded verifier.

FIG. 5B illustrates waveforms of CLK port values, DIN port values, and DOUT port values.

FIGS. 5C-5D illustrate assembly code for a single-threaded verifier.

FIG. 5E illustrates trace information for a single-threaded verifier.

FIG. 6A illustrates source code for a multi-threaded verifier.

FIG. 6B illustrates assembly code for a multi-threaded verifier.

FIG. 6C illustrates trace information for a multi-threaded verifier.

The Figures depict preferred embodiments of the present invention for purposes of illustration only. One skilled in the art will readily recognize from the following discussion that alternative embodiments of the structures and methods illustrated herein can be employed without departing from the principles of the invention described herein.

### DETAILED DESCRIPTION OF PREFERRED EMBODIMENTS

In one embodiment, a circuit is tested using a device under test (DUT), which is a description of the circuit's static structure (including gates, wires, and a behavioral model) written in a Hardware Description Language (HDL); a circuit simulator, which is a program that simulates the circuit's operation based the DUT; and a circuit simulation verifier, which is a program written in a Hardware Verification Language (HVL), such as Vera or Jeda, that controls the circuit simulator and verifies the simulator's behavior.

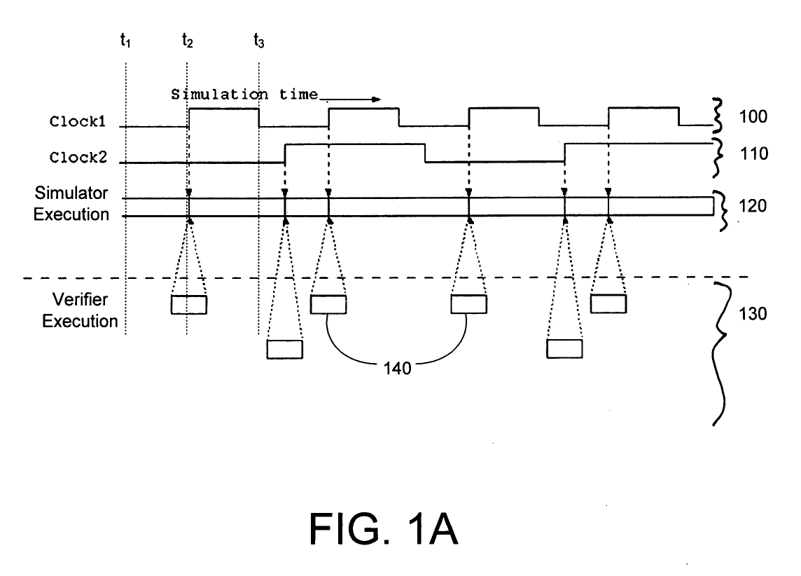

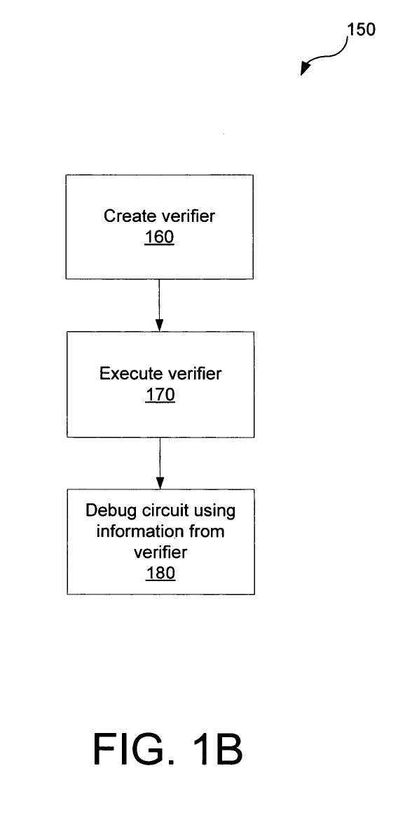

In one embodiment, the circuit simulator and the circuit simulation verifier run alternatively (i.e., not concurrently). For example, for each simulation time slot, the simulator executes first, and the verifier executes second. This embodiment is illustrated in FIG. 1A. FIG. 1A illustrates a clock-based timeline for simulator execution and verifier execution. As the timeline is traversed from left to right, the index of the simulation time slot increases. For example, a simulation time slot representing a clock of time 100 would be to the left of a simulation time slot representing a clock of time 200. FIG. 1A indicates three simulation time slots, which occur at t₁, t₂, and t₃, respectively, where t₁<t₂<t₃.

The first portion 100 of FIG. 1A represents the state of a clock named Clock1. Specifically portion 100 illustrates the rising and falling edges of Clock1. Similarly, the second portion 110 of FIG. 1A represents the state of a clock named Clock2. Notice that the rising and falling edges of Clock2 occur at different times than the rising and falling edges of Clock1.

The third portion 120 of FIG. 1A represents the execution of the simulator. Specifically, the part of portion 120 that corresponds to a particular simulation time slot represents the execution of the simulator at that time slot. The fourth portion 130 of FIG. 1A represents the execution of the verifier. Specifically, the part of portion 130 that corresponds to a particular simulation time slot represents the execution of the verifier at that time slot.

When the simulator executes (portion 120), the clock is driven cyclically (e.g., portions 100 or 110). When the verifier gets control, the simulator is at a particular simulation time slot (e.g., clock cycle). The verifier executes all statements that can execute at that simulation time slot. This is shown by portion 130, where a “block” 140 of verifier execution occurs within a single simulation time slot. After the verifier has finished executing for a particular time slot, the verifier returns control back to the simulator. This embodiment helps avoid race conditions occurring between the simulator and the verifier. The verifier's internal clock can be driven from inside or outside the verifier. In one embodiment, the positive edge of the clock signal is used to determine a timeout.

Debugging

FIG. 1B illustrates a flowchart of a method for using a circuit simulation verifier to debug a circuit. In the illustrated embodiment, the method 150 comprises three steps: 1) creating 160 a verifier to drive the simulator; 2) executing 170 the verifier, which drives the simulator and collects information; and 3) debugging 180 the circuit using the collected information.

In one embodiment, the verifier drives the simulator within a debugging environment. The debugger can be passive and/or interactive. A passive debugger collects information during execution of the verifier and/or simulator. This information can be recorded in a file, sometimes called a “dump file,” and used to debug the circuit. An interactive debugger enables a user to control the execution of the verifier and/or simulator. A debugger can also have a code viewer that enables the user to inspect source code and/or assembly code of the verifier and/or simulator.

Information collected during simulator execution can include values and value changes of elements, such as nodes and wires, along with clock cycle and timestamp information. This information can be in any format, such as Value Change Dump (VCD) format as defined in the Verilog 2001 standard (IEEE 1364). A special user interface can be used to display the information, for example as waveforms for specified nodes. Such a waveform viewer is relatively easy to implement (because the nodes are static) and is known to those of ordinary skill in the relevant art.

Information collected during verifier execution can include information about the verifier's execution, such as execution sequence, variable access, and clock cycles and timestamps. Variable access information can include, for example, creation, deletion, and modification of variables and their values. Collectively, this information is known as “trace information.” A special user interface can be used to display the information. In one embodiment, since a verifier usually contains dynamic variable allocation and thread creation, a waveform viewer is not used to view the information. Instead, the information is displayed on the screen in, for example, textual form. This information can be presented in a window and/or using a command-line interface.

Information collected during simulator execution and information collected during verifier execution can be saved to the same file or to different files. Clock cycle and timestamp information can be used to correlate the information temporally if it has been saved to multiple files. In one embodiment, a file is compressed and/or truncated to save storage space.

For the sake of clarity, the description below will focus on debugging the circuit using information collected during execution of only the verifier. However, it should be kept in mind that information collected during execution of the simulator can also be used to debug the circuit.

An interactive debugger enables a user to control the execution of the verifier and/or simulator by, for example, executing the verifier and/or simulator line-by-line. A user can also assign a value to a variable. In one embodiment, a breakpoint command in the verifier invokes the debugger, thereby suspending the execution of the verifier. The debugger can provide a command-line interface to the verifier, a graphical user interface to the verifier, or both.

In one embodiment, available debugger commands include: 1) “print” or “p,” which evaluates an expression; 2) “continue” or “c,” which continues execution of the verifier; 3) “next” or “n,” which executes the next line of the verifier; 4) “step” or “s,” which goes to next line of the verifier and breaks out of the current thread; 5) “stepany” or “sa,” which goes to next line of the verifier and breaks out of all threads; 6) “where,” which shows the current state of execution; 7) “list” or “l,” which shows source code or assembly code of the verifier; 8) “assign,” which assigns a value to an expression; 9) “up” and “down,” which move the scope up and down, respectively; 10) “thread,” which moves the scope to a particular thread; 11) “show vars,” which shows all variables in the current scope; 12) “show lvars,” which shows all local variables in the current scope; 13) “show threads,” which shows all threads in the system; 14) “show 1threads,” which shows the threads in the current scope and child threads forked therefrom; and 15) “window,” which invokes a graphical user interface. In one embodiment, a scope mapping mechanism determines, based on the execution context, an address in memory that stores the value of a particular variable. In one embodiment, this address is determined using a stack index, which will be discussed below.

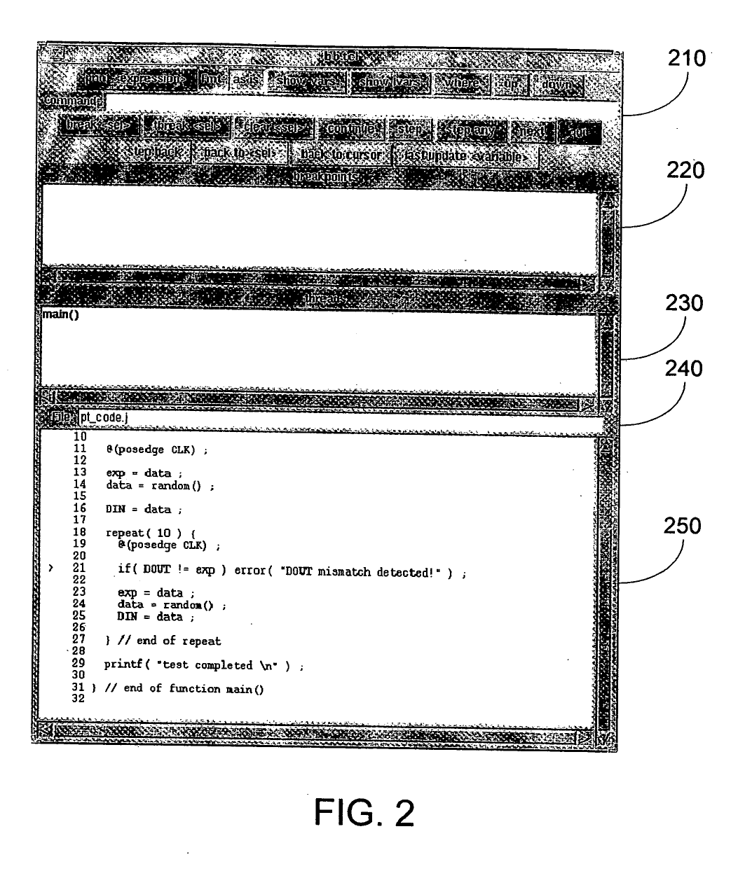

FIG. 2 illustrates a graphical user interface to the verifier. The illustrated embodiment 200 includes a command portion 210, a breakpoint portion 220, a thread portion 230, a file name portion 240, and a code portion 250. Command portion 210 enables the user to execute a debugger command, for example by typing it into the text field or by pressing a button. Breakpoint portion 220 displays active breakpoints (of which there are none in the illustrated embodiment). Code portion 250 displays the source code or assembly code of the verifier. In one embodiment, the current execution point is shown by a symbol, such as the symbol “>”. In another embodiment, a breakpoint and a temporary breakpoint are also shown by symbols, such as the symbols “B” and “T”, respectively. File name portion 240 displays the name of the file whose contents are being shown in code portion 250. Thread portion 230 displays active threads. In one embodiment, selecting a thread in thread portion 230 will display that thread's code location in code portion 250.

In one embodiment, an interactive debugger enables a user to execute a verifier backwards to a past execution point or clock cycle. The recorded sequence information is traced back, and the internal state of the verifier's execution (e.g., the value of each variable) is reconstructed at the past point. In one embodiment, if a waveform was being displayed, the waveform will be synchronized with the past execution point or clock cycle. Once the verifier has reached the past point, debugger commands such as “show” can be used to obtain information about the verifier's internal state.

The verifier can be executed backwards to any past execution point. The debugger command that is used depends on the desired past execution point. If the desired past execution point is one line of source code or assembly code back from the current execution point, the command “step back” can be used.

If the desired past execution point is a point where the value of a particular variable was modified, the commands “trace variable <vname>” or “last update <vname>” can be used, where <vname> is the name of the appropriate variable and can be specified by typing it or by selecting it in code portion 250. The verifier will be executed backward to the point where the value of the appropriate variable was modified.

If the desired past execution point is a particular line of source code, the command “back to <lnum>” can be used, where <lnum> is the number of the appropriate line and can be specified by typing it or by selecting the line in code portion 250.

In one embodiment, a user can specify a past execution point by selecting, via a cursor in a displayed waveform, a specific point in time or a specific value change and then using the command “back to cursor.” The verifier will be executed backward to the simulation time slot of the cursor. Since verifier execution occurs within a single simulation time slot, the user can specify, for a past point, whether the verifier has already executed at the point.

Source Code, Assembly Code, and Trace Information

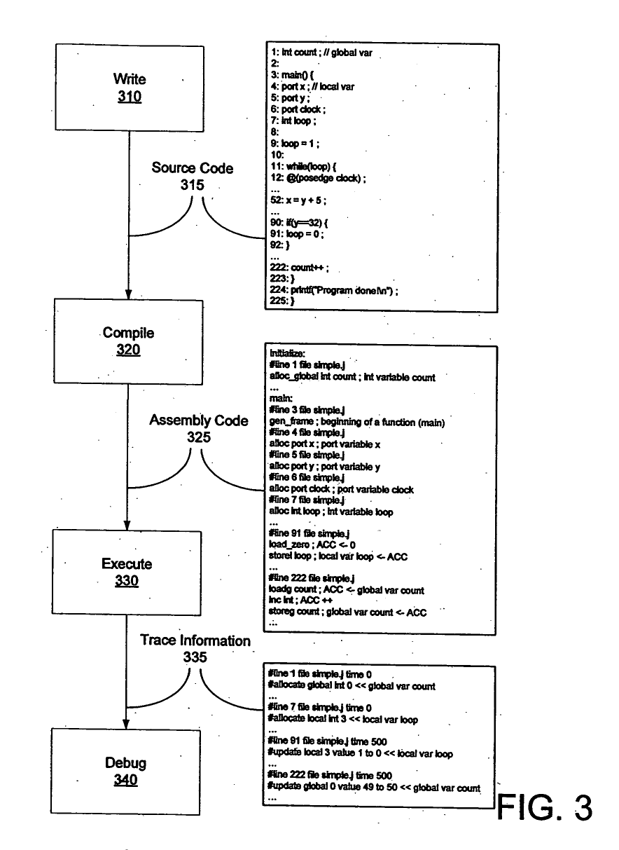

The above functionality is enabled by using trace information that was collected during verifier and/or simulator execution. FIG. 3 illustrates a flowchart of a method for producing source code, assembly code, and trace information. In the illustrated embodiment, verifier source code 315 (e.g., HVL) is written 310. This source code 315 is then compiled 320, which results in assembly code 325. When the assembly code 325 is executed 330, trace information 335 is collected. The illustrated embodiments of source code 315, assembly code 325, and trace information 335 are merely examples and are not necessarily related to the same verifier. In other words, compiling source code 315 may not produce assembly code 325.

Recall that an HVL enables a user to create a program that manipulates data using variables and operations. In one embodiment, an HVL program manages information at run-time using a stack. For example, when a procedure is called, a stack frame (or “activation record”) is created and pushed onto the run-time stack. When the procedure ends and control is returned to the caller, the frame is popped off of the stack. In one embodiment, a frame stores information used by an execution of a procedure. This information can include, for example, local variable values and machine/processor state. If machine/processor state information is stored, it can be used to restore the state after a procedure call has finished.

In one embodiment, information in a frame is referenced using an offset (“stack index”) from a frame address. This frame address can be, for example, the address of the “top” of the stack (also known as the “frame pointer”). In one embodiment, when a procedure is called, the frame pushed on the stack includes the value of the current frame pointer, along with an index to this value (known as the “stack pointer”). The value of the stack pointer is then used as the new value of the frame pointer. When the procedure finishes, the current frame pointer value is used as the new stack pointer value, and the old frame pointer value is popped of the stack and replaces the current frame pointer value.

Compiling 320 a program written in HVL (e.g., source code 315) to create assembly code 325 is similar to compiling programs written in other languages. In one embodiment, a run-time stack is used, so compiling 320 a source code 315 statement that declares a procedure creates an assembly code 325 statement that creates a frame. For example, compiling 320 a source code 315 statement of the form “<fname>(<args>) {“would create the assembly code 325 “<fname>:” (a label indicating the entry point of the function) and “gen_frame” (a statement), where <fname> is a name of a function (procedure), and <args> is a set of arguments to the function. In one embodiment, the statement “gen_frame” creates a frame in the stack space, along with a frame pointer and a stack pointer. Variables are dynamically allocated on the stack. The stack pointer points to the last valid entry on the stack, and the frame pointer points to the start point of the allocated variable. The previous value of the frame pointer is saved

As another example, compiling 320 a source code 315 statement of the form “<dtype> <varname>;” would create the assembly code 325 statement “alloc <dtype> <varname>”, where <dtype> is a data type (e.g., int) and <varname> is a name of a local variable. Thus, compiling 320 the source code 315 statement “int x;” would create the assembly code 325 statement “alloc int x”. In one embodiment, the assembler loader system stores a mapping between variable names and stack indices, such that <varname> can be resolved to a stack index. This stack index, when combined with the frame pointer, determines the address where a variable's value is stored. Stacks, frames, and activation records are known to those of ordinary skill in the art and are further discussed in “Compilers: Principles, Techniques, and Tools” by A. Aho, R. Sethi, and J. Ullman, Addison-Wesley, 1988, pp. 396-400.

As yet another example, compiling 320 a source code 315 statement of the form “<varname>=1;” would create the assembly code 325 statements “load_one” (load the value “1” into the ACC register) and “storel <varname>;” (store the value of the ACC register as the value of the local variable <varname>), where <varname> is a name of a local variable. Thus, compiling 320 the source code 315 statement “x=1;” would create the assembly code 325 statements “load_one” and “storel x”. A specification of assembly code 325 created by compiling 320 a program written in an HVL (e.g., source code 315) can be found in Appendix B. Note that this specification includes support for debugging. For example, the “breakpoint” statement stops execution of the HVL program (the verifier) and calls the debugger, which presents the debugging environment to the user.

In one embodiment, the assembly code 325 that is created includes additional information that is useful for debugging. In one embodiment, debugging information comprises the symbol “#” followed by the information itself. Typically, debugging information does not manipulate the state of execution. One example of debugging information is line and file information. When a line of source code 315 is compiled 320, the line number and file name of the source code are added to the assembly code 325 (in addition to the “standard” assembly code that would be generated by the line of source code). In one embodiment, line and file information is expressed as “#line <inum> file <fname>”, where <lnum> is the line number and <fname> is the file name.

When assembly code 325 is executed 330, trace information 335 is collected. Trace information 335 enables the internal state of the verifier's execution (e.g., the value of each variable) to be reconstructed at a past point.

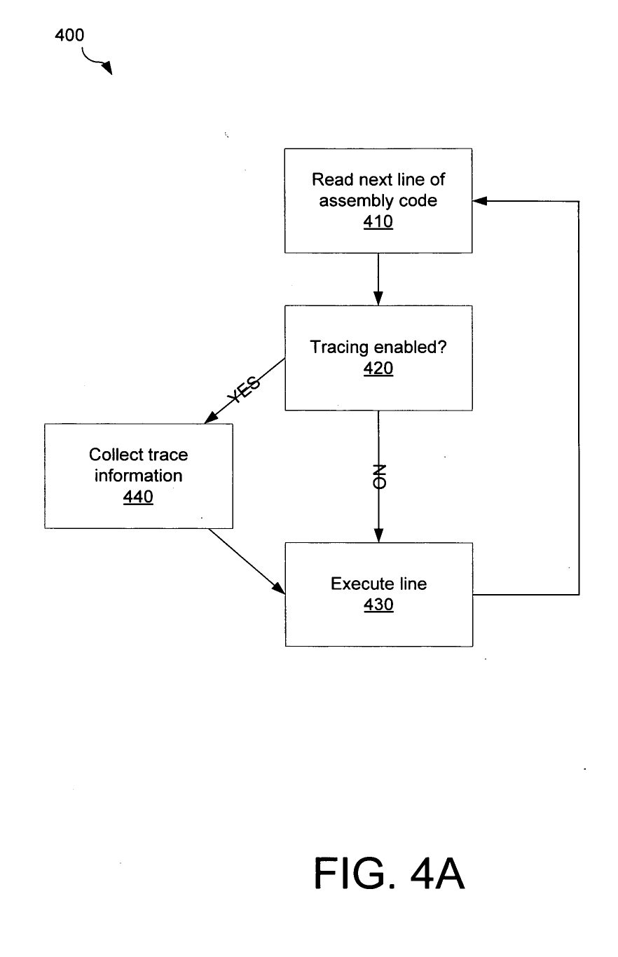

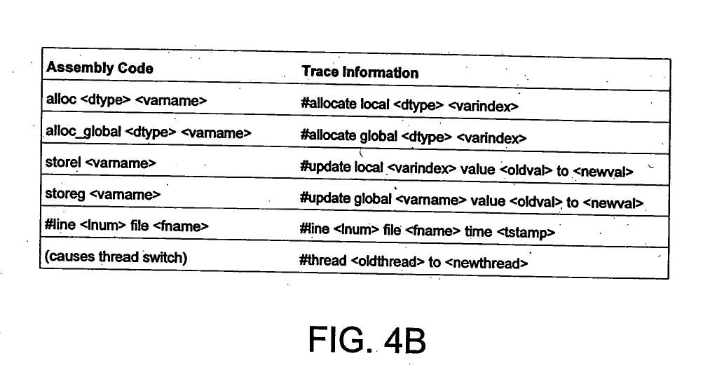

FIG. 4A illustrates a flowchart of a method for collecting trace information and executing assembly code. In general, method 400 processes assembly code 325 line-by-line, collects trace information (as appropriate), and executes the line. A line of assembly code 325 is read 410. It is determined 420 whether tracing functionality is enabled. If it is not enabled, then the line is executed 430, and method 400 begins again by reading 410 the next line. If it is enabled, then trace information 335 is collected 440, the line is executed 430, and method 400 begins again by reading 410 the next line.

The trace information 335 that is collected 440 depends on the line of assembly code 325 that was read 410. FIG. 4B illustrates a table of assembly code and trace information. A row of the table specifies what trace information 335 is collected 440 for a particular line of assembly code 325.

In one embodiment, trace information regarding variable allocation is collected 440. The trace information 335 “#allocate local <dtype> <varindex>” is collected 440 for the assembly code 325 “alloc <dtype> <varname>”, where <dtype> is a data type (e.g., int), <varindex> is a local variable's stack index, and <varname> is the local variable's name. The trace information 335 “#allocate global <dtype> <varindex>” is collected 440 for the assembly code 325 “alloc_global <dtype> <varname>”, where <dtype> is a data type (e.g., int), <varindex> is a global variable's index, and <varname> is the global variable's name. As described above, in one embodiment, the assembler loader system stores a mapping between variable names and indices, such that <varname> can be resolved to an index.

In another embodiment, trace information regarding variable value changes is collected 440. The trace information 335 “#update local <varindex> value <oldval> to <newval>” is collected 440 for the assembly code 325 “storel <varname>”, where <varindex> is a local variable's stack index, <oldval> is the local variable's old value, <newval> is the local variable's new value, and <varname> is the local variable's name. The trace information 335 “#update global <varname> value <oldval> to <newval>” is collected 440 for the assembly code 325 “storeg <varname>”, where <varname> is a name of a global variable, <oldval> is the global variable's old value, and <newval> is the global variable's new value.

In yet another embodiment, trace information regarding debugging information is collected 440. The trace information 335 “#line <lnum> file <fname> time <tstamp>” is collected 440 for the assembly code 325 “#line <lnum> file <fname>”, where <lnum> is the line number, <fname> is the file name, and <tstamp> is a simulation timestamp of when the assembly code was executed.

### EXAMPLE

### Single-Threaded Verifier

The following example will be used to explain how a debugger can enable a user to execute a verifier backwards. Assume that a device under test (DUT) has three ports: DIN (an input), DOUT (an output), and CLK (a clock). In one embodiment, the DUT is an amplifier, and it behaves as follows: Given an input (DIN) of value x, the DUT generates an output (DOUT) of value 2x. However, the output value cannot exceed 32. In other words, DOUT is saturated at 32.

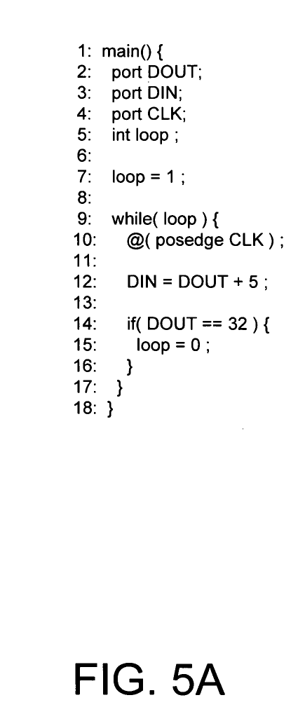

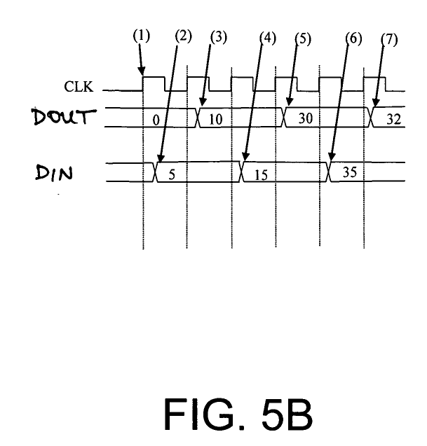

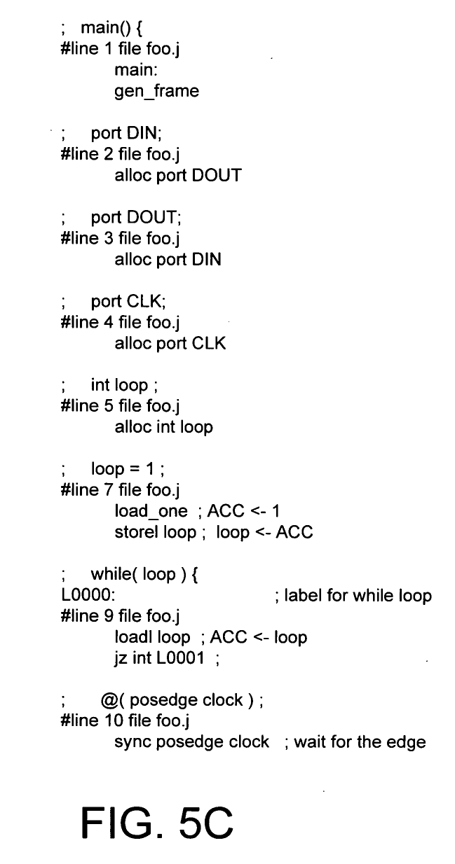

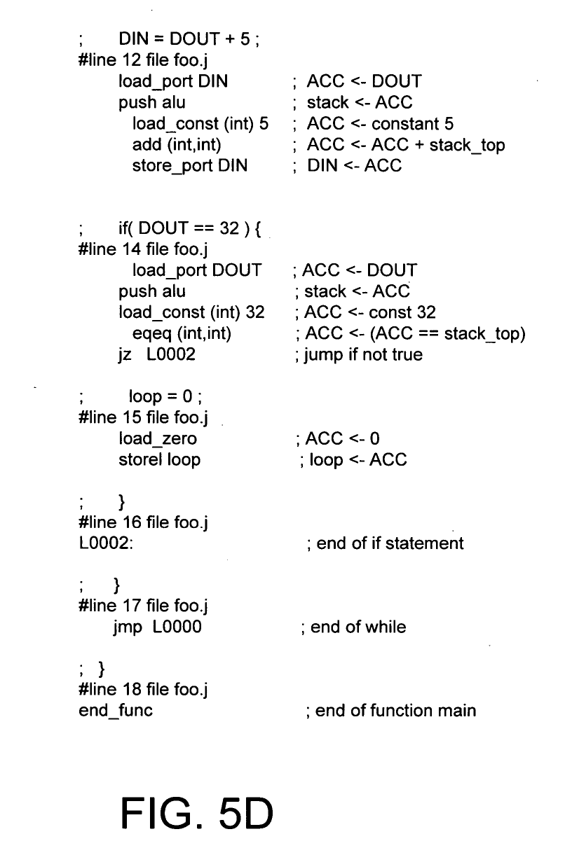

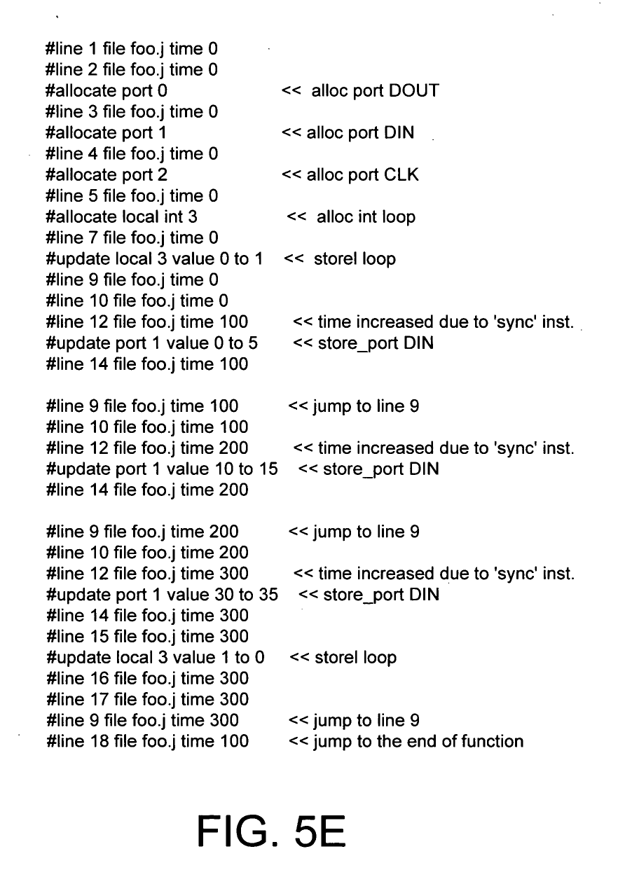

FIG. 5A illustrates source code for a single-threaded verifier. In the illustrated embodiment, the source code 315 is located in a file named “foo.j”. Source code 315 can be used to test the DUT. Note that lines 6, 8, 11, and 13 of source code 315 are blank. These blank lines were added to make source code 315 more readable.

In one embodiment, the source code in FIG. 5A operates as follows: A function “main” is defined (line 1). Three port variables are declared (DOUT in line 2, DIN in line 3, and CLK in line 4). An integer variable “loop” is declared (line 5) and assigned the value 1 (line 7). The following is repeated as long as loop does not equal zero (line 9): The verifier is synchronized with the next positive edge of the CLK signal (line 10). DIN is assigned the value of DOUT plus 5 (line 12). If the value of DOUT is 32 (line 14), then loop is assigned the value 0 (line 15).

The value at DOUT varies according to the value at DIN, as described above. FIG. 5B illustrates waveforms of CLK port values, DIN port values, and DOUT port values. At the beginning of the simulation, the DUT has been reset and the value of DIN has been initialized to zero. Since DIN equals zero, DOUT also equals zero. At line 10 in FIG. 5A, the verifier waits for the positive edge of CLK. At (1) in FIG. 5B, the verifier changes the simulator time to the positive edge of CLK.

At line 12 in FIG. 5A, DIN is driven to (DOUT+5). Since DOUT was 0, DIN is driven to 5. This occurs at (2) in FIG. 5B. The DUT then amplifies DIN so that DOUT equals 10. This occurs at (3) in FIG. 5B. Since DOUT does not equal 32 (line 14 in FIG. 5A), the variable loop still equals 1, and the while loop begins another iteration.

At line 10 in FIG. 5A, the verifier waits for the positive edge of CLK. After this occurs (shortly before (4) in FIG. 5B), DIN is driven to (DOUT+5) (line 12 in FIG. 5A). Since DOUT was 10, DIN is driven to 15. This occurs at (4) in FIG. 5B. The DUT then amplifies DIN so that DOUT equals 30. This occurs at (5) in FIG. 5B. Since DOUT does not equal 32 (line 14 in FIG. 5A), the variable loop still equals 1, and the while loop begins another iteration.

At line 10 in FIG. 5A, the verifier waits for the positive edge of CLK. After this occurs (shortly before (6) in FIG. 5B), DIN is driven to (DOUT+5) (line 12 in FIG. 5A). Since DOUT was 30, DIN is driven to 35. This occurs at (6) in FIG. 5B. The DUT then amplifies DIN so that DOUT equals 32. (DOUT would have equaled 70, had it not reached its saturation point of 32.) This occurs at (7) in FIG. 5B. Since DOUT now equals 32 (line 14 in FIG. 5A), the variable loop is set to zero, the while loop ends, and the program in FIG. 5A terminates.

FIGS. 5C-5D illustrate assembly code for a single-threaded verifier. This assembly code 325 was created by compiling 320 the source code 315 illustrated in FIG. 5A. Since the assembly code 325 did not fit onto one page, it has been divided into two parts. FIG. 5C illustrates the first part, while FIG. 5D illustrates the second part.

The first line of the source code 315 is “main( ) {”. Compiling this source code 315 creates the assembly code 325 “func main”. However, before this assembly code 325 is written to the assembly code file, other information is added to the file. This information includes a comment containing the source code 315 to aid in understanding. Thus, the first line of the assembly code 325 is “; main( ) {” which is a comment that contains line 1 of the source code 315. The second line of the assembly code 325 is “#line 1 file foo.j”, which is debugging information (specifically, line number and file name information regarding the source code 315). The third line of the assembly code 325 is “func main”. The rest of the assembly code 325 shown in FIGS. 5C-5D follows a similar pattern, and includes source code 315 in comments, debugging information, and code to execute. Note that since lines 6, 8, 11, and 13 of source code 315 are blank, no assembly code 325 is created for these lines.

FIG. 5E illustrates trace information for a single-threaded verifier. This trace information 335 was collected while executing 330 the assembly code 325 illustrated in FIGS. 5C-5D, according to the method illustrated in FIG. 4A and the table illustrated in FIG. 4B. In the illustrated embodiment, a clock cycle takes 100 units of simulation time. Thus, a simulation time of 100 units corresponds to one clock cycle, a simulation time of 200 units corresponds to two clock cycles, etc.

The table in FIG. 4B indicates what trace information 335 is collected when a particular assembly code 325 statement is executed 330. In the illustrated embodiment, if a particular type of assembly code 325 statement is not in the table, then no trace information is collected. In another embodiment (not shown), more or less trace information, or different trace information, is collected. The first line of the assembly code 325 is a comment, so no trace information 335 is collected. The second line is debugging information, so that information is collected and, in the illustrated embodiment, a timestamp is also collected. The third line creates a function, and no trace information is collected. The rest of the trace information 335 shown in FIG. 5E follows a similar pattern. Note that since no assembly code 325 was created for lines 6, 8, 11, and 13 of source code 315, no trace information 335 was created, either.

Note that assembly code 325 statements directed to variable allocation are present in the table. Thus, the trace information 335 “#allocate port 0” is collected when the assembly code 325 statement “alloc port DOUT” is executed 330. Note also that the illustrated trace information 335 includes comments (indicated by the symbol “<<”) that include the corresponding assembly code 325, to aid in understanding.

Reconstructing the Internal State of the Verifier's Execution

One important aspect of executing a verifier backwards is reconstructing the internal state of the verifier's execution (e.g., the value of each variable) at the past point. This past state of verifier execution can be determined by using trace information 335 to modify the current state. In one embodiment, a state of verifier execution includes 1) values of variables (both local and global, including any ports or clocks) and 2) the execution point within the verifier (e.g., which assembly code 325 statement was last executed 330).

In one embodiment, a past state of verifier execution is determined as follows: The last (most recent) line of trace information 335 is read. If that line includes a value change of a variable, then the value of that variable (in the “current” state) is set to the “old” value. If that line includes debugging information (such as line number and file name), then the execution point within the verifier (in the “current” state) is set to the “old” value (e.g., the number of the previous line). This procedure can be repeated multiple times, depending on how far backward the user wants to execute the verifier. After a line of trace information 335 has been processed, the “current” state of verifier execution becomes the previous state as modified based on the trace information 335.

### EXAMPLE

### Multi-Threaded Verifier

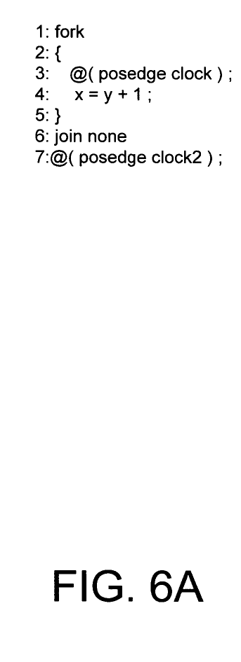

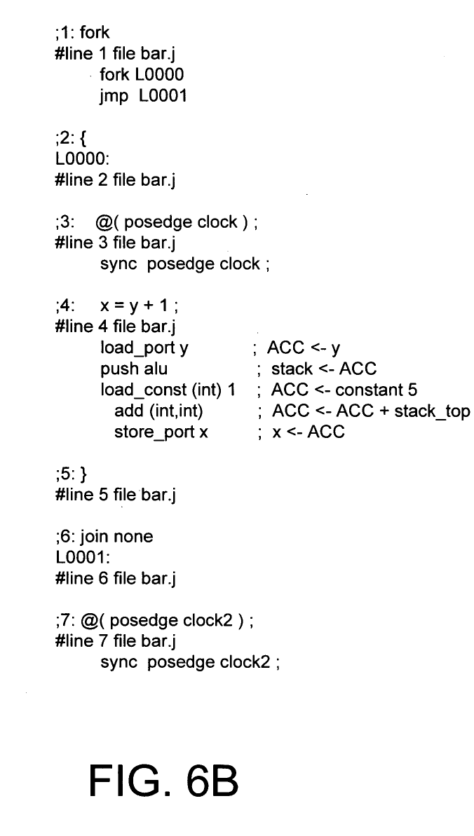

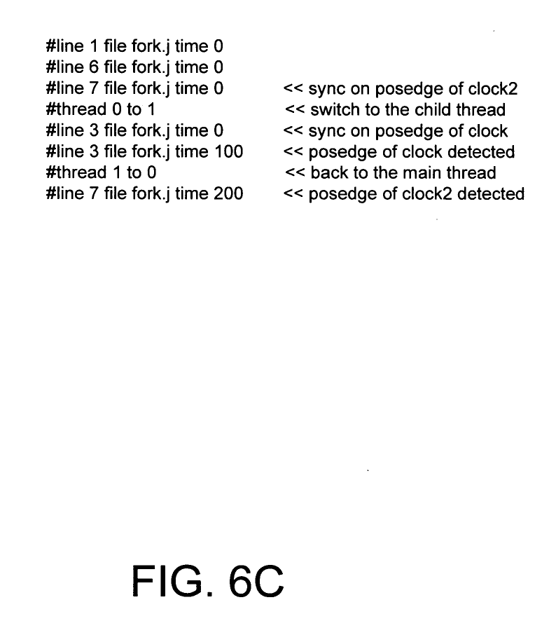

As discussed above, a program written using an HVL can enable circuit simulation based on dynamic threads. Thread functions can include fork, join, join_any, join_none, thread_pause, and thread join, as described in Appendix A. FIG. 6A illustrates source code for a multi-threaded verifier. In the illustrated embodiment, the source code 315 is located in a file named “bar.j”.

In one embodiment, the source code in FIG. 6A operates as follows: A fork is created (line 1). Statements placed between a fork (line 2) and a join (line 5) are executed as a thread. These statements include: The verifier is synchronized with the next positive edge of the clock signal (line 3). The variable x is assigned the value of the variable y plus 1.

A join_none is executed (line 6). This means that the following proceeds without waiting for the completion of any of the forked threads (i.e., concurrently with the forked threads): The verifier is synchronized with the next positive edge of the clock2 signal (line 7).

FIG. 6B illustrates assembly code for a multi-threaded verifier. This assembly code 325 was created by compiling 320 the source code 315 illustrated in FIG. 6A. The first line of the source code 315 is “fork”. Compiling this source code 315 creates the assembly code 325 “fork L0000” and “jmp L0001”. However, before this assembly code 325 is written to the assembly code file, other information is added to the file. This information includes a comment containing the source code 315 to aid in understanding. Thus, the first line of the assembly code 325 is “;1:fork” which is a comment that contains line 1 of the source code 315. The second line of the assembly code 325 is “#line 1 file bar.j”, which is debugging information (specifically, line number and file name information regarding the source code 315). The third and fourth lines of the assembly code 325 are “fork L0000” and “jmp L0001”, respectively. The rest of the assembly code 325 shown in FIG. 6B follows a similar pattern, and includes source code 315 in comments, debugging information, and code to execute.

FIG. 6C illustrates trace information for a multi-threaded verifier. This trace information 335 was collected while executing 330 the assembly code 325 illustrated in FIG. 6B, according to the method illustrated in FIG. 4A and the table illustrated in FIG. 4B. The illustrated trace information 335 would be collected if, when the assembly code 325 were executed, the positive edge of clock occurred prior to the positive edge of clock2. (In that situation, there is a thread switch.) In the illustrated embodiment, a clock cycle takes 100 units of simulation time. Thus, a simulation time of 100 units corresponds to one clock cycle, a simulation time of 200 units corresponds to two clock cycles, etc.

The first line of the assembly code 325 is a comment, so no trace information 335 is collected. The second line is debugging information, so that information is collected and, in the illustrated embodiment, a timestamp is also collected. The third and fourth lines are “fork L0000” and “jmp L0001”, respectively, and no trace information is collected. The rest of the trace information 335 shown in FIG. 6C follows a similar pattern.

Note that the last line of the table in FIG. 4B indicates that the trace information 335 “#thread <oldthread> to <newthread>” is collected when an assembly code 325 statement causes execution to switch from one thread to another, where <oldthread> is the index of the thread that was previously executing and <newthread> is the index of the thread that will execute. One example of such a statement would be “sync <edge> <pname>”, where <edge> is an edge (e.g., posedge, negedge, bothedge, and noedge) and <pname> is a name of a port variable (such as a clock). Thus, the trace information 335 “#thread 0 to 1” is collected when the assembly code 325 statement “sync posedge clock” is executed 330. Note also that the illustrated trace information 335 includes comments (indicated by the symbol “<<”) that include the corresponding assembly code 325, to aid in understanding.

Similar to a single-threaded verifier, the past state of execution of a multi-threaded verifier can be determined by using trace information 335 to modify the current state. In one embodiment, a state of verifier execution includes 1) values of variables (both local and global, including any ports or clocks), 2) the execution point within the verifier (e.g., which assembly code 325 statement was last executed 330), and 3) information regarding the thread that is executing. In one embodiment, information regarding a thread includes an individual stack space, including values for local and temporal variables.

Also similar to a single-threaded verifier, a past state of verifier execution can be determined as follows: The last (most recent) line of trace information 335 is read. If that line includes a value change of a variable, then the value of that variable (in the “current” state of the thread) is set to the “old” value. If that line includes debugging information (such as line number and file name), then the execution point within the verifier (in the stack space of the thread that is executing) is set to the “old” value (e.g., the number of the previous line). If that line includes thread switch information, then the stack space of the other thread is used.

This procedure can be repeated multiple times, depending on how far backward the user wants to execute the verifier. After the first line of trace information 335 has been processed, the “current” state of verifier execution becomes the previous state as modified based on the trace information 335.

In the above description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations herein. This apparatus can be specially constructed for the required purposes, or it can comprise a general-purpose computer selectively activated or reconfigured by a computer program stored in the computer. Such a computer program can be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems can be used with programs in accordance with the teachings herein, or it can prove convenient to construct more specialized apparatuses to perform the required method steps. The required structure for a variety of these systems appears from the description. In addition, the present invention is not described with reference to any particular programming language. It will be appreciated that a variety of programming languages can be used to implement the teachings of the invention as described herein.

The present invention provides various mechanisms for automatically presenting an analysis report for a prospective trade or other transaction, with a minimum of user effort. One skilled in the art will recognize that the particular examples described herein are merely illustrative of representative embodiments of the invention, and that other arrangements, methods, architectures, and configurations can be implemented without departing from the essential characteristics of the invention. Accordingly, the disclosure of the present invention is intended to be illustrative, but not limiting, of the scope of the invention, which is set forth in the following claims.

### Appendix A—HVL Features

Appendix A describes features of an exemplary Hardware Verification Language (HVL). A circuit simulation verifier written in an HVL can create multiple threads, and a thread can run synchronously with various simulator events (e.g., a clock edge). The verifier can interact with the simulator by using the commands get_cycle( ), get_time( ), get_plusarg( ), unit_delay( ), and exit( ).

Clock Handling

A test bench can have one or more clock domains. A statement can be evaluated with reference to any clock defined in the test bench. The “@” symbol is used to delay the execution of a statement a number of clock cycles. For example, “@5 STATEMENT” means that STATEMENT should be evaluated after 5 clock cycles. The clock and clock edge can be specified in parentheses “(EDGE CLK).” For example, “@5 STATEMENT (negedge tck)” means that STATEMENT should be evaluated after 5 clock cycles of clock tck based on its negative edge. A statement with a clock delay will synchronize with the specified edge after the specified number of cycles has elapsed. If no edge or clock is specified, the default edge and clock are used (e.g., posedge and CLOCK).

Timed Expressions

An expression can be evaluated within a multi-cycle window. The syntax “@DELAY,WINDOW (EXPRESSION),” where DELAY represents how many cycles should elapse before the window begins and WINDOW represents the size of the window (in cycles), determines whether EXPRESSION is true at some point during the multi-cycle window. For example, “@5,20 (x==1)” determines whether x==1 is true after 5 cycles have elapsed and at every cycle thereafter for the next 20 cycles. The syntax “@@DELAY,WINDOW (EXPRESSION),” where DELAY represents how many cycles should elapse before the window begins and WINDOW represents the size of the window (in cycles), determines whether EXPRESSION is always true during the multi-cycle window.

The evaluation (e.g., True or False) can then be used for further computation. Also, timed expressions can be combined by using the functions p_and( ) (logical AND) or p_or( ) (logical OR). For example, “p_or (@5,10 (EXP1), @5,10 (EXP2))” determines the logical OR of two timed expressions. A timed expression can be used, for example, to sample an incoming signal with respect to the clock of a transmit port. Each transmit port clock would run in its own clock domain.

Aspect Oriented Programming (AOP)

AOP is a programming paradigm that provides explicit language support to extract “aspects” (behavior that cuts across the typical divisions of program functionalities, such as classes). With respect to hardware verification, AOP code can be used to implement, for example, debug message logging, performance measurement, coverage measurement, and error injection.

Aspect code is called an “Aspect block,” which is created by using the aspect datatype. The executable part of an Aspect block is called “advice” and is “woven” into test bench code by linking the Aspect block to the test bench code. The code insertion point for the advice is called the “pointcut.” Pointcut uses regular expressions to determine the code insertion point, either through an exact match of a function name or by specifying a regular expression pattern.

Concurrent Programming

Concurrent programming is enabled by using fork commands and join commands to work with threads. Statements placed between a fork and a join are executed concurrently as threads. There are three types of join commands: join( ) proceeds when all forked threads have completed; join_any( ) proceeds when one forked thread has completed (threads that haven't completed are kept for execution, but parent won't wait for the result; and join_none( ) proceeds without waiting for any forked thread's completion (i.e., it will continue to execute the following statement). Other commands used to control threads include thread_pause( ) and thread_join( ).

### Appendix B—Assembly Code Specification

Appendix B contains a specification of assembly code created by compiling a program written in an exemplary Hardware Verification Language (HVL).

1. Data Allocation

1.1 Global Data

Global data is allocated in the system area at the beginning of execution.

alloc_global <dtype> <name>

1.2 Local Data

Local data is allocated to the current stack.

alloc <dtype> <name>

1.3 Data Type

Data type for allocation (<dtype>) can be port, int, bit <dsize>, etc.

2. Function and Label

2.1 Function Entry

A function is declared with a function block.

func <name> <op code> func_end

2.2 Label

A program location can be referenced with a label. A label comprises a name followed by “:”.

3. ALU Operation

Data is manipulated on a register “ALU” with ALU operation instructions. Binary operation is executed over the data on ALU register and the value at the top of the stack.

3.1 Type Code

ALU operation is associated with a data type code (<type>), which can be int, bit, etc.

3.2 Increment/Decrement Operations

dec <type>: ACC−

inc <type>: ACC++

3.3 Binary Operations

minus (<type1>,<type2>): ACC←stack[sp-1]−ACC

plus (<type1>,<type2>): ACC←stack[sp-1]+ACC

times (<type1>,<type2>) : ACC←stack[sp-1]*ACC

div (<type1>,<type2>): ACC←stack[sp-1]/ACC

mod (<type1>,<type2>): ACC←stack[sp-1]%ACC

and (<type1>,<type2>): ACC←stack[sp-1]&ACC

or (<type1>,<type2>): ACC←stack[sp-1]|ACC

eor (<type1>,<type2>): ACC←stack[sp-1]ˆACC

nand (<type1>,<type2>): ACC←stack[sp-1]˜&ACC

nor (<type1>,<type2>): ACC←stack[sp-1]˜|ACC

neor (<type1>,<type2>) ACC←stack[sp-1]˜ˆACC

rshift (<type>): ACC←stack[sp-1]>>ACC

urshift (<type>): ACC←stack[sp-1]>>>ACC

lshift (<type>): ACC←stack[sp-1]<<ACC

lt (<type1>,<type2>): ACC←stack[sp-1]<ACC

gt (<type1>,<type2>): ACC←stack[sp-1]>ACC

eqeq (<type1>,<type2>): ACC←stack[sp-1]==ACC

le (<type1>,<type2>): ACC←stack[sp-1]<=ACC

ge (<type1>,<type2>): ACC←stack[sp-1]>=ACC

ne (<type1>,<type2>) : ACC←stack[sp-1]!=ACC

3.4 Unary Operations

u_minus (<type>): ACC←−ACC

u_tilde (<type>): ACC←˜ACC

u_not (<type>): ACC←!ACC

u_and (<type>): ACC←&ACC

u_or (<type>): ACC←|ACC

u_eor (<type>): ACC←ˆACC

u_nand (<type>): ACC←&ACC

u_nor (<type>): ACC←|ACC

u_neor (<type>): ACC←ˆACC

3.5 Constant Operations

load_zero: ACC←0

load_one: ACC←1

load_const (type) data: ACC←data

4. Stack Operations

A value on the stack can be accessed with the following operations:

pop <n>: pop n-entries from stack and discard

push alu: stack[sp++]←ACC

pop alu: ACC←stack[—sp]

copy alu <n>: ACC←stack[sp−n−1]

5. Stack Frame

A local variable is referenced with an offset from the frame register. A frame is created on a function call and released on return.

gen_frame: create stack frame for leaf function; this frame will be released on “return” instruction

6. Call, Jump, Return

A program execution can be moved with the following:

jmp <label>: unconditional jump

jz <type> <label>: jump if ALU is zero

jnz <type> <label>: jump if ALU is not zero

return: return from a function

call <fnc_name>: call function

7. Concurrent

Threads can be created and manipulated with the following:

fork label: create and execute child thread; create a thread with program counter (address of next instruction to be executed) set to label, put it to ready queue

join: wait for children; wait until all the children complete (exit)

spoon: wait for a child; wait until one of the children complete

exit: terminate self thread

terminate: terminate children

8. Debug

breakpoint: stop execution and call debugger

9. Sync on clock edge

A thread can be synchronized to an edge of a port signal. Thread execution is put on hold until the edge event is detected. If no active thread exists in the verifier, control is returned to the simulator.

sync <edge> <port_name>: Sync on the port value

<edge>:=posedge, negedge, bothedge, noedge

10. Memory Access

A value in memory is accessed via ALU register.

10.1 Local Variable Access

A local variable is allocated on the stack space dynamically and accessed via the frame register.

loadl <index>: ACC←local_var[<index>]

storel <index>: local_var[<index>]←ACC

10.2 Global Variable Access

A global variable is accessed with a direct address.

loadg <name>: ACC←global_var[<name>]

storeg <name>: global_var[<name>]←ACC

10.3 Port Access

A port is a connection to a signal node in the simulator. It can be accessed as a variable.

load_port <name>: ACC←port[<name>]

store_port <name>: port[<name>]←ACC

11. Comments

An assembler instruction is ended with “;”, and the rest of the line is ignored as a comment.

; this is a comment

### Appendix C—Glossary

Appendix C contains definitions of selected terms.

AOP—Aspect Oriented Programming.

aspect—Datatype; used to create an Aspect block.

bit—Datatype; Verilog-like multi-value bit vector (e.g., can hold x and z state); can be vectored as bit [7:0] bus

CLK—Source synchronous clock.

compare(x y)—Returns 1 if x==y; else, returns 0.

event—Datatype; provides triggers; can be used for thread synchronization.

negedge—Negative edge.

port—Datatype; interface to corresponding node or wire in simulator; attributes include clock (reference clock), sample (sample timing and depth), and drive (drive timing).

portset—Datatype; interface to simulator; a set of ports.

posedge—Positive edge.

semaphore—Datatype; provides mutex and synchronization mechanisms for threads; can be used to sequentially order arbitration.

signal—Datatype; interface to simulator; pointer to a port.

What is claimed is:

1. A system for testing a circuit, comprising:
a software model of the circuit;
a circuit simulator adapted to simulate the circuit based on the software model; and
a circuit simulation verifier adapted to provide an input to the circuit simulator and adapted to receive an output from the circuit simulator;
wherein execution of the circuit simulation verifier is controlled by user input.

2. The system of claim 1, wherein execution of the circuit simulation verifier is halted by user input.

3. The system of claim 2, wherein execution of the circuit simulation verifier has been halted, and wherein execution of the circuit simulation verifier is restarted by user input.

4. The system of claim 1, wherein the circuit simulation verifier comprises a plurality of code statements and wherein user input executes only one statement of the circuit simulation verifier.

5. The system of claim 1, wherein the circuit simulation verifier comprises a variable and wherein user input determines a value of the variable.

6. The system of claim 1, wherein execution of the circuit simulation verifier comprises execution of a plurality of threads.

7. The system of claim 1, wherein execution of the circuit simulation verifier comprises collection of information and wherein the collected information comprises one element of a group containing a memory allocation of a variable, a value of a variable, a value change of a variable, a code statement that has been executed, a timestamp, and a clock cycle.

8. The system of claim 1, wherein the circuit simulation verifier has been executed through a first execution point to a second execution point, and wherein user input restores the circuit simulation verifier to the first execution point.

9. The system of claim 8, wherein user input indicates the first execution point by specifying one element of a group containing a name of a variable, a line number of a code statement, a timestamp, a clock cycle, and a point of a waveform.

10. The system of claim 8, wherein the circuit simulation verifier had a first state at the first execution point and wherein the circuit simulation verifier had a second state at the second execution point, and wherein user input changes the state of the circuit simulation verifier from the second state to the first state.

11. The system of claim 10, wherein the state of the circuit simulation verifier comprises one element of a group containing a timestamp and a clock cycle.

12. The system of claim 10, wherein the state of the circuit simulation verifier comprises one element of a group containing a value of a variable and an execution point of the circuit simulation verifier.

13. A computer program product containing a computer readable medium for testing a circuit, the computer readable medium comprising:
a first program code for modeling the circuit;
a second program code for simulating the circuit based on the first program code; and
a third program code for providing an input to the second program code and for receiving an output from the second program code;
wherein execution of the third program code is controlled by user input.

14. A user interface for testing a circuit, comprising:
a window for displaying a state of a circuit simulation verifier; and
a control for receiving user input, the state of the circuit simulation verifier being modified responsive to the received user input.
